(19) United States
(12) Patent Application Publication
(10) Pub. No.: US 2004/0066767 A1
(43) Pub. Date: Apr. 8, 2004

(54) Using the training sequence code to identify individual mobile stations

(76) Inventors: Stefan Lidbrink, Hagersten (SE); Jorgen Ersten, Sollentuna (SE)

Correspondence Address: NIXON & VANDERHYE, PC, 1100 N GLEBE ROAD, 8TH FLOOR, ARLINGTON, VA, 22201-4714, US

(21) Appl. No.: 10/468,233

(22) PCT Filed: Mar. 8, 2002
(86) PCT No.: PCT/SE02/00435

(30) Foreign Application Priority Data
Mar. 9, 2001 (SE) 0100846-5

(51) Int. Cl. H04J 3/00; H04B 7/212

(52) U.S. Cl. 370/336; 370/347

(57) ABSTRACT

In the invention interfering mobile stations (MS1, MS2) are identified in a base station (BS), measuring the signal strength of the mobile stations, by the training sequence code they use during normal communication with a serving base station. In an evaluation unit (E) the received training sequence is correlated with a known training sequence (TSC) and when there is a match a signal (SSS) is produced corresponding to the signal strength of the strongest of the interfering mobile stations (MS1 or MS2). The invention may be used in a Virtual Singel System (VSC) used for indoor cellular telecommunication.

### TECHNICAL FIELD OF THE INVENTION

The present invention relates to the cellular mobile communication area and in particular how to identify mobile stations in the radio network environment.

### BACKGROUND

A cellular telephone system is, as the name implies, operating in cells each covering a certain smaller area of a greater territory assigned to an operator giving mobile telecommunication service to its subscribers. Each cell has at least one base station communicating with mobile stations occupying the area of the cell. A certain number of frequencies is allocated to the operator and a task for him is to optimise his resources in serving his subscribers. As the number of frequencies is limited the frequencies must be used efficiently. Depending on the services one or several frequencies are used in a particular cell. None of these frequencies may be used in neighbouring cells because of interference. The reuse distance when the same frequency can be used again is at least the cross-distance of the neighbouring cell. It is thus assumed in an ideal case that the radio coverage of a base station is its own cell and partly into the neighbouring ones but not beyond that.

The sizes of the cells depend on the number of users in the cells and in urban environments, where the number of users can be quite high, the cells tend to get small and even smaller they will get with modern cellular indoor solutions.

When the mobile moves from one cell to another it eventually looses contact with the cell it has left and a handover to the new cell becomes necessary. Normally the mobile prepares this handover by listening to the Broadcast Control Channel (BCCH) of neighbouring base stations and reporting signal strength measurements to the base station control equipment, which decides to make the handover whenever appropriate—mobile assisted handover, MAHO. It is also possible that the mobiles are passive in the handover process and that the base stations measure the uplink signal strength from the mobiles and initiates the handover based on these uplink measurements—network controlled handover, NCHO.

In digital cellular telecommunication systems like the Global System for Mobile communication, GSM, the information is transmitted in the form of bursts in short time slots, each burst including a certain amount of digital bits. Some of these bits are added for the purpose of restoring the digital information, which might have been more or less seriously degraded when transmitted over the radio interface due to, for example, time dispersion. In GSM a sequence of added bits is denoted the Training Sequence Code, TSC, and is known by the receiver. A limited number (eight according to the GSM of today) of such training sequences are used and allotted the different communication channels of the system according to the particular base station involved or in another arbitrary way in order to evenly spread out the sequences. The receiver examines the received training sequence and compares it with a known one in an adaptive equalisation process and the outcome of this comparison is used to correct the transmitted information bits.

A modern indoor solution is the VSC-concept (Virtual Single Cell). According to this concept a number of synchronised base station are situated for example on each floor of an office building creating a large number of small cells. All base stations use the same BCCH-frequency and virtually a big cell for the whole building is established. A description of this concept is found in the published international patent application WO 97/13386.

A difficulty with the VSC is that MAHO cannot be used because the mobiles are unable to discriminate between the neighbouring base stations all transmitting their BCCH on the same frequency. Thus a network controlled solution is the only choice necessitating mobile station identification. At least when the mobile stations transmit on the same frequency and at the same time, in the same time slot in a GSM-system, it is impossible to identify and measure the signal strength of individual mobile stations. This is a quite probable occurrence in indoor solutions like the just mentioned VSC concept where a tight reuse of frequencies is desirable. A prior art solution is to order the mobile by an identity request to transmit the information normally used by the mobile when registering into the system, like the IMSI- and IMEI-number. These numbers are unique for the subscriber and the equipment the subscriber is using.

### SUMMARY OF THE INVENTION

The mentioned solution of identification of mobile stations using the specified identity information used by the mobiles when entering the system suffers from the drawback of generating an additional traffic load and interference. Particularly when such identity information has to be sent out regularly for the purpose of preparing handover solely controlled by the network, this problem becomes significant.

An object of the invention is to find solutions to the problems of identifying mobile stations, which do not cause additional traffic and interference.

Another object of the invention is to find pieces of information already sent out by a mobile station, which “uniquely enough” characterise the mobile.

One such piece is the information sent out by the mobile for the purpose of correcting bit errors and restoring the original message after the reception. An example of such a piece is the training sequence code according to the GSM-specification.

The invention uses this information, which may differ among mobile stations occupying a certain service area, to identify individual mobile stations.

Another aspect of the invention is to allocate different training sequences to mobile stations within a certain area in order to make them individually distinguishable.

The invention makes it easier to use and further develop common-BCCH systems with uplink measurements for preparing handovers in such systems.

### BRIEF DESCRIPTION OF THE DRAWINGS

FIG. 1 shows a building with an indoor cellular system.

FIG. 2 illustrates a typical burst in a time slot according to GSM.

FIG. 3 is a schematic diagram of an equipment for discriminating between mobile stations according to the invention.

FIG. 4 is a flowchart describing the different steps of the invented method.

### DETAILED DESCRIPTION OF THE DRAWINGS AND OF PREFERRED EMBODIMENTS

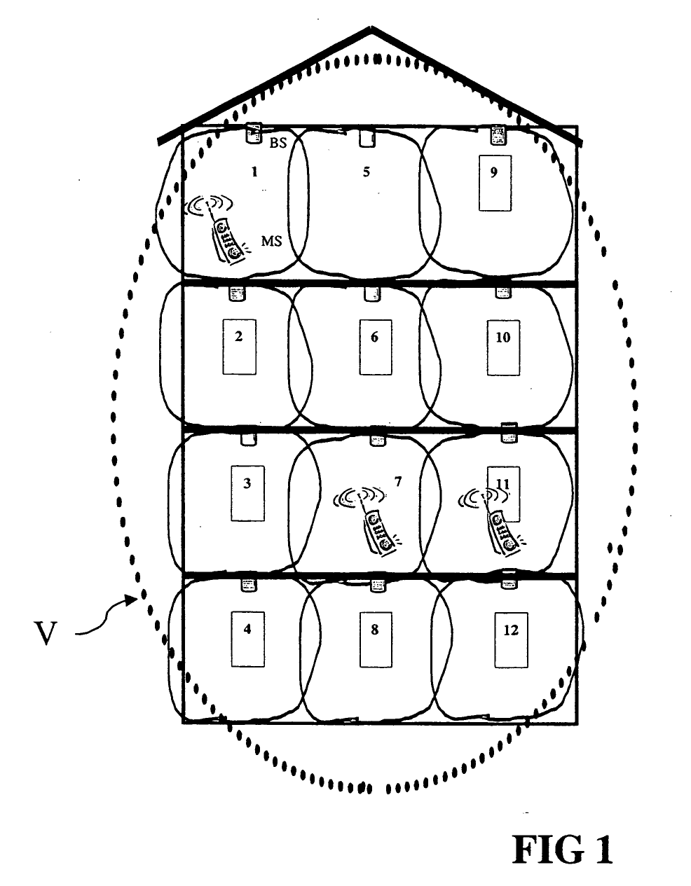

FIG. 1 shows an office building with an indoor cellular telephone system. The building has four floors with three cells on each floor—twelve cells 1-12 all together. The system works according to the VSC concept and all the cells are incorporated within one big cell, V, covering the whole building. In the ceilings radio base stations, BS, are mounted communicating with mobile stations MS used by people working in the office. All the base stations are synchronised and use the same frequency for their BCCHs. Because of this all the cells 1-12 looks virtually like one cell, V, from the outside of the building.

When the signal strength of a connection tends to get too low to keep the connection going, the system starts preparing handover of the connection from the mobile to a better base station. In a VSC system the preparation starts with measuring the signal strength of the mobile station by nearby situated base stations. Individual mobiles are identified by the frequency and time slot they use at the moment. Due to the tight reuse of frequencies in the VSC system, it may very well happen that a measuring base station can hear two or more mobiles transmitting on the same frequency and in the same time slot. In that case there will be no meaningful measurement result if the mobile cannot be identified by some other means.

According to the invention a hidden code transferred anyway in the transmitted burst i.e. the training sequence code is used for the identification.

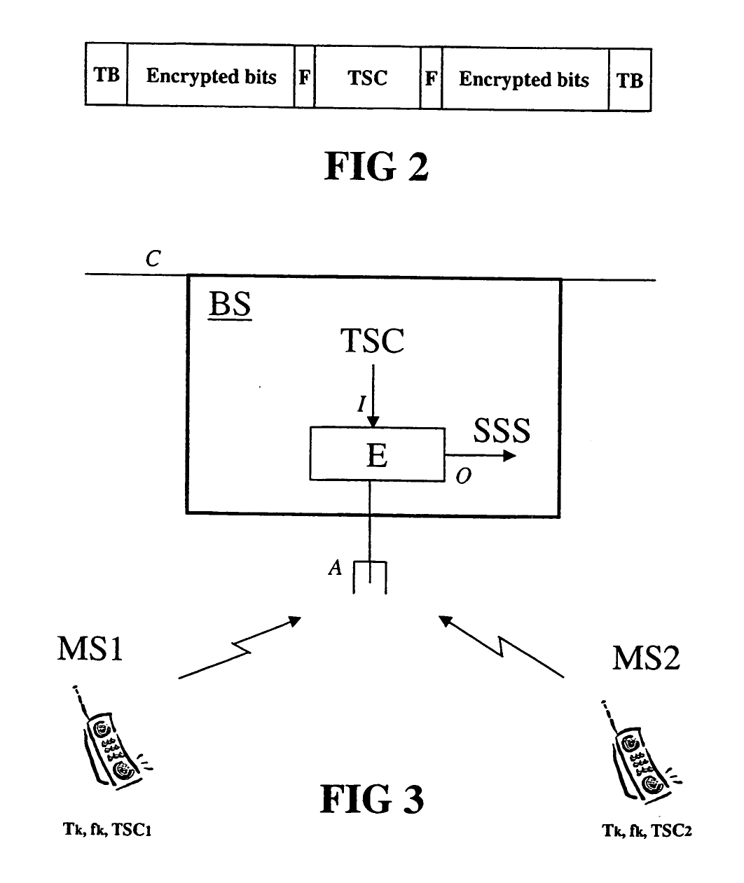

FIG. 2 illustrates how a normal burst in GSM is organised. Surrounded by tailbits, TB, payload sequences with encrypted bits and flags, F, the training sequence code, TSC, of 26 bits is found in the middle. When the burst reaches the receiver it may have been distorted along the radio path. The purpose of the training sequence, which is already known in the receiver, is to correct normal messages due to time dispersion occurred in the radio interface and help recover any lost information with the assumption that the training sequence has undergone the same distortion as the rest of the burst.

There are eight different training sequences to choose among according to the existing GSM-standard. In prior art the sequences are related to the Base Station Identity Code, BSIC, identifying the base station to which the mobile will be connected. The last three bits of that code—eight possible combinations—specifies the related training sequence. Thus normally, the mobile will be allotted a training sequence in accordance with the BSIC of the serving base station.

According to the inventive idea another scheme of allotting training sequences is used. At least when two or more mobiles communicate with their respective base station using the same frequency and time slot, they must be allotted different training sequences irrespective of the BSIC of the base stations. What TSC to use for any dedicated channel can be set and sent to the mobile in the Channel Description Information Element during the Assignment Command. A suitable solution would be to let the base station controller functionality choose and assign a TSC that is not currently used by any other mobile, which is at the same time using the same frequency and time slot.

FIG. 3 illustrates the case where a measuring base station listens to signals transmitted from two mobiles MS1 and MS2, that are known to transmit on the same frequency, fk, and time slot, Tk, but with different training sequences, TSC1 and TSC2. The base station BS, mounted in a ceiling, C, receives a mixed signal at its antenna A and the strongest signal is distinguished, depending on the receiver sensitivity. The signal is evaluated in an evaluation unit E to which the respective known training sequences TSC of the two mobiles are input at I. The evaluation unit, E, makes correlation calculations, which result in an output value at O representing the identity of the strongest received signal SSS of signals transmitted by the mobiles MS1 or MS2.

An alternative solution is to introduce a new software routine in the base station receiver. With this routine normal-bursts from the mobiles received by the base station, pass the steps of the adaptive equalisation process in the receiver eight times for the eight different training sequences. Only when there is a match between received TSC and one of the eight sequences, an output representing the strongest signal will appear.

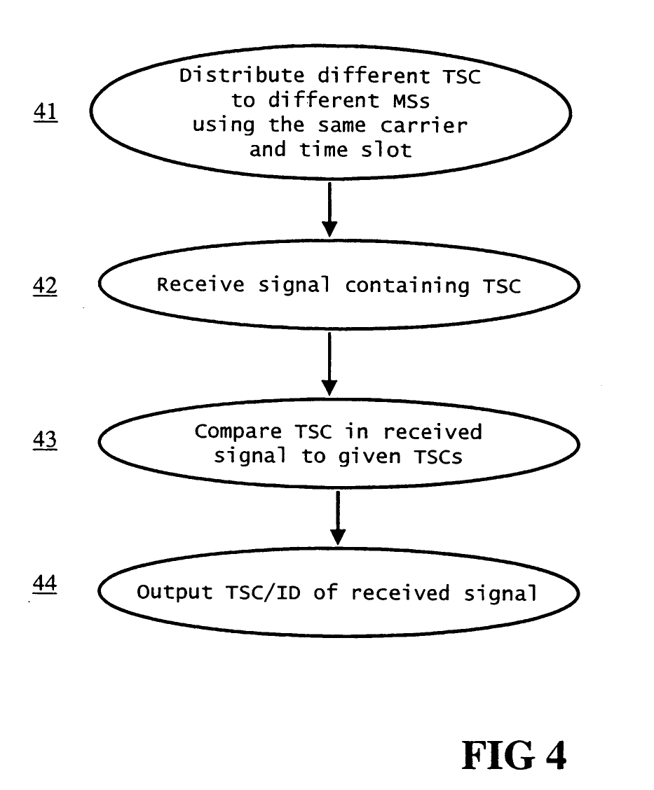

The basic procedure/functionality for a system for identification of mobile stations using the training sequence is outlined in the flowchart of FIG. 4. In a first preparation step 41 different training sequence codes, TSC, are distributed to mobile stations using the same carrier frequency and time slot. This step preferably coincides with the assignment of the time slot to the mobile when the training sequence and time slot are related. The next step 42 is to receive a signal in the base station to be measured containing a specific training sequence. In step 43 the content of the received signal is correlated to known training sequences. Lastly in step 44 the identity of the mobile radio station transmitting the received signal on the particular carrier frequency in the certain time slot is output based on the distributed TSC in the first step 41.

The invention has mainly been described with the training sequence according to GSM as the identity information used.

However it lies within the general idea of the invention to use other kinds of information sent out by the mobiles “anyway” and known by the receiver. Such information could be different modulating schemes, other more or less unique codes used when transforming the information and the like.

The invention is not intended to be limited only to the embodiments described in detail above. Changes and modifications may be made without departing from the invention. It covers all modifications within the scope of the following claims.

1. Method in a digital telecommunication system intended for identification of a transmitter (MS) broadcasting digital information in the form of a radio signal on a carrier frequency at a certain time and wherein the radio signal comprises digital code information (TSC) for the purpose of restoring the original information after reception of the radio signal Characterised In that said code information (TSC) is used to identify the transmitter (MS1) when it interferes with another transmitter (MS2) of the system broadcasting on essentially the same carrier frequency and at the same time.

2. The method of claim 1 wherein said code information is represented by the training sequence code (TSC) according to the Global System for Mobile communication, GSM.

3. The method of claim 1 or 2 wherein the radio signal is broadcasted in the form of a burst in a time slot and wherein different code information (TSC) are assigned to transmitters in the system broadcasting on the same carrier in the same time slot.

4. A method of preparing handover of a connection between a mobile station (MS1) and a base station (BS) in a cellular telecommunication system according to the network controlled handover principle, NCHO, with passive mobiles, where the signal strength and/or quality of the mobile station is measured by serving and neighbouring base stations (BS) Characterised In that the method of identification in claims 1-3 is used in the base stations to discriminate between the mobile station (MS1) measured on and other mobiles (MS2) sending on the same frequency at the same time.

5. Arrangement in a radio receiver (BS) in a cellular telecommunication system, which arrangement is intended for identifying interfering radio transmitters (MS1, MS2) broadcasting on the same frequency at the same time Characterised In means (E) in the receiver for evaluation of a digital code (TSC) incorporated in the received message and selected from a group of such codes known by the receiver (BS), which code differs between the interfering transmitters (MS1, MS2).

6. The arrangement of claim 5 wherein said digital code (TSC) is represented by the training sequence code used in the receiver (BS) for correcting normal messages due to time dispersion occurred in the radio interface and that the group of codes is the limited number of available training sequences in said cellular telecommunication system.

7. The arrangement of claim 5 or 6 wherein the means for evaluation (E) has an input channel (I) for the different codes (TSC) and an output channel (O) for output of a value (SSS) representing the signal strength of the strongest of the interfering transmitters (MS1, MS2) when there is a match between the input code and the code of the strongest transmitter.

8. The arrangement of claim 6 wherein the evaluation means (E) comprises a software routine according to which successive comparisons of available training sequences (TSC) with the received message are made, wherein an output (O) is produced, representing the highest signal strength (SSS), when one of the available training sequences and the training sequence of the transmitter (MS) with the highest signal strength are the same.
